(19) United States
(12) Patent Application Publication
(10) Pub. No.: US 2004/0139443 A1
(43) Pub. Date: Jul. 15, 2004

(54) Systems and methods for recreating configuration data

(76) Inventors: Mark G. Hatle, Bloomington, MN (US); Joseph W. Green, Sunnyvale, CA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/342,195

(22) Filed: Jan. 13, 2003

(51) Int. Cl. G06F 15/163

(52) U.S. Cl. 719/310

(57) ABSTRACT

Systems and methods are disclosed for processing configuration data of a program executing on a computer system. In an exemplary method for processing configuration data, the method includes determining first configuration data associated with the program, the first configuration data comprising one or more parameters; generating a web-based browser screen comprising the first configuration data and displaying the web-based browser screen to a user via a browser; receiving via the browser second configuration data representing the first configuration data with one or more modifications to the one or more parameters of the first configuration data; and storing the second configuration data. The process may further include, parsing a session log comprising one or more parameters relating to prior execution of one or more programs, and determining which of the parameters in the session log relate to the program; wherein generating a web-based browser screen comprising the first configuration data comprises inserting into the web-based browser screen the values associated with the one or more parameters relating to the program.

### BACKGROUND OF THE INVENTION

I. Field of the Invention

The present invention generally relates to the field of computer software and, more particularly, methods and systems for recreating configuration data.

II. Background and Material Information

Software must be installed on computers. The installation process may take place on a variety of platforms. The installation process may include providing a series of screens of information to users and receiving data from users.

One program that can be used on a variety of platforms is called a “browser.” Examples of graphical browsers include Netscape Navigator™ from Netscape Communications Corporation and Internet Explorer™ from Microsoft Corporation. Examples of a text browser are Lynx, available at http://lynx.browser.org/ and Links, available at http://links.sourceforge.net/. Using a browser, a user can view or respond to objects such as for example, screens of information. The browser retrieves the information from storage and visually displays it to the user.

Browser pages are programmed using a computer language such as hypertext markup language (HTML). HTML files (or “.html” files) are stored on a server and define the content and layout of browser pages. Communication between the user's browser and a server is based on a request/response paradigm involving Hypertext Transfer Protocol (HTTP) or other known protocols. A browser makes a HTTP request (such as to view a page), and then the server provides a response (to permit the page to be displayed by the browser). Upon receipt of a request, the server accesses the requested page and provides a response containing the requested page to the browser.

Requests from a browser may contain GET or POST commands, as well as information identifying the user. GETs and POSTs are commands used to submit data to the server based on the user's actions within the page. For example, the commands may be used to submit data associated with a response page, such as a screen provided by the server. In a standard HTML communication there are two requests, a “GET” request followed by a “POST” request. When you connect to a browser page the browser sends a “GET” request to the server, the server then gets the page and passes it to the browser in response. If the HTML page contains a FORM, there will be a “submit” button of some type on the page. When the user clicks this submit button, a “POST” request is sent from the browser to the server. The POST request contains the values the user put into the FORM fields. If the address given to the server in either a GET or POST request is a Common Gateway Interface (CGI) program, the server uses the CGI to pass the information in a known format to the CGI programs.

A program may be installed on a variety of computers, either by a computer manufacturer, an IT department, or an end user. Configuration information is used to ensure that a program is installed in the same way on multiple computers. Thus, there is a need for recreation and automation of configuration data to ease the installation and configuration process. Accordingly, there is a need for improved methods and systems for recreating configuration data. Moreover, there is a need for systems and methods that are capable of evaluating requirements for information and inserting the information before sending requests to a user.

### SUMMARY OF THE INVENTION

Methods and systems consistent with embodiments of the present invention provide for recreating configuration data by processing configuration data of a first program executing on a computer system. In accordance with one embodiment of the invention, a method is provided for determining first configuration data associated with the first program, the first configuration data comprising one or more parameters; generating a web-based browser screen comprising the first configuration data and displaying the web-based browser screen to a user via a browser; receiving via the browser second configuration data representing the first configuration data with one or more modifications to the one or more parameters of the first configuration data; and storing the second configuration data.

In accordance with another embodiment of the invention, a method is provided for determining first configuration data associated with the first program, the first configuration data comprising one or more parameters; generating a web-based browser screen comprising the first configuration data and displaying the web-based browser screen to a user via a browser; receiving via the browser screen confirmation of the first configuration data; and storing the first configuration data.

It is to be understood that both the foregoing general description and the following detailed description are exemplary and explanatory only and are not restrictive of the embodiments of the present invention, as claimed.

### BRIEF DESCRIPTION OF THE DRAWINGS

The accompanying drawings, which are incorporated in and constitute a part of this specification, together with the description, serve to explain features and exemplary embodiments of the invention. In the drawings:

FIG. 1 is a pictorial diagram illustrating an exemplary system for recreating configuration data, consistent with an embodiment of the invention;

FIG. 2 is a block diagram of an exemplary platform, consistent with an embodiment of the invention;

FIG. 3 is a block diagram of an exemplary program, consistent with an embodiment of the invention;

FIG. 4 is a flow diagram of an exemplary process for recreating configuration data from the perspective of a CGI script, consistent with an embodiment of the invention;

FIG. 5 is a block diagram of exemplary types of requests, consistent with an embodiment of the invention.

FIG. 6 is a flow diagram of an exemplary process for recreating configuration data from the perspective of a proxy engine, consistent with an embodiment of the invention; and

FIG. 7 is a flow diagram of an exemplary process for recreating configuration data from the perspective of a user, consistent with an embodiment of the invention.

### DETAILED DESCRIPTION

Consistent with embodiments of the invention, methods and systems are provided for the recreation of configuration data. In general, during the installation of software on a computer, a browser starts the installation process by sending a GET request to a server. The server passes the GET request to a CGI Script via a proxy engine. The CGI Script responds with an information screen requesting data. The proxy engine can modify the information screen. In particular, the proxy engine can enter configuration data into the screen. The information screen is then sent to the user, via the web server and its web browser, with the configuration data. The web browser displays the information screen to the user. The user can accept or modify the configuration data and then resubmit the data, via a POST request generated by the browser and sent to the server. The POST request is processed by the proxy engine to validate and store the user data (which may be identical to the configuration data), before passing the data to the CGI Script. At that point the CGI program handles the “work” of configuration. If the installation is being automated, the proxy engine creates dummy GET and POST requests based on the data in memory.

Embodiments of the present invention may be implemented in connection with various types of configuration operations. By way of a non-limiting example, an implementation will be described with reference to a configuration during installation of a program. As can be appreciated by those skilled in the art, embodiments of the invention can be implemented for other types of configuration operations, such as software installation, software configuration, setting passwords, partitioning disks, controlling file system configuration data, setting software preferences, etc.

Embodiments of the present invention may be implemented in connection with various types of computing tools. For example, an exemplary implementation will be described with reference to a platform.

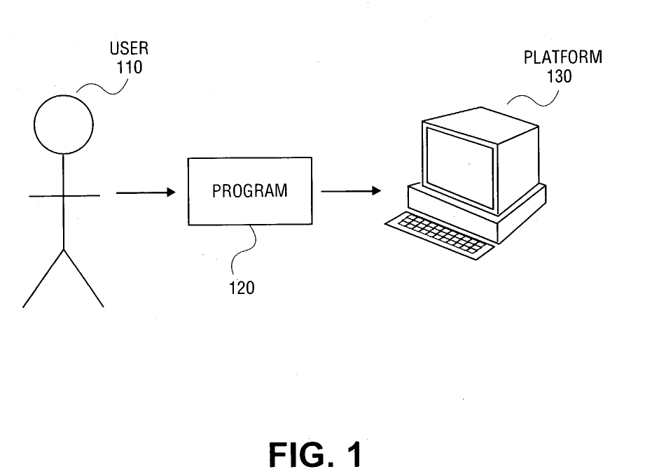

FIG. 1 depicts an exemplary system 100 for recreation of configuration data, consistent with an embodiment of the invention. As shown in FIG. 1, system 100 includes user 110, program 120, and platform 130. Program 120 may be software that user 110 wishes to install on platform 130. Platform 130 may be, for example a workstation, PDA, mobile phone, next-generation phone, settop box, thin-client device, small computing device, and/or other computing device, as will be evident to those skilled in the art.

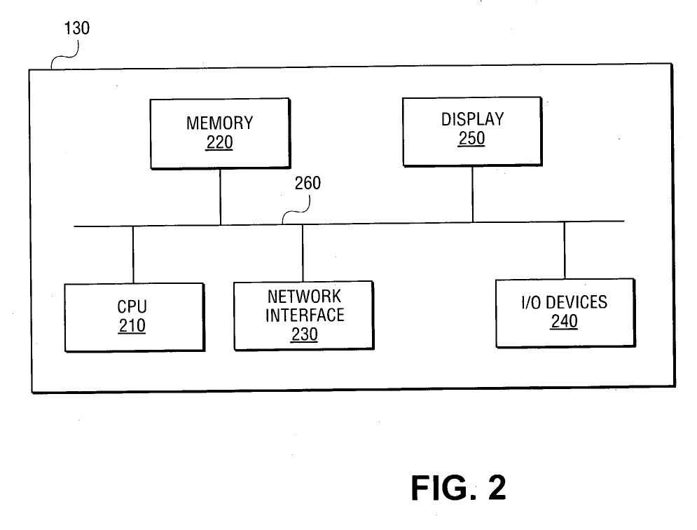

FIG. 2 is a block diagram of an exemplary platform 130, consistent with an embodiment of the invention. Platform 130 may include a number of components, such as a processor or central processing unit (CPU) 210, a memory 220, a network interface 230, I/O devices 240, and/or a display 250. Such components may be, interconnected by a bus 260. CPU 210 may be a microprocessor such as from the Pentium® family of microprocessors manufactured by Intel Corporation. However, any other suitable microprocessor, micro-, mini-, or mainframe computer may be used, such as a micro-controller unit (MCU), or a digital signal processor (DSP).

Memory 220 may include a random access memory (RAM), a read-only memory (ROM), a video memory, mass storage, and/or cache memory such as fixed and removable media (e.g., magnetic, optical, or magnetic optical storage systems or other available mass storage technology). Memory 220 may store support modules such as, for example, a basic input/output system (BIOS), an operating system (OS), a program library, a compiler, an interpreter, and/or a text-processing tool. For simplicity, these modules are not illustrated. Further, memory 220 may contain an operating system, an application routine, a program, such as a calibration program or application program, an application-programming interface (API), and/or other instructions for performing methods consistent with embodiments of the invention.

Network interface 230 may include physical and virtual connections. Physical connections, such as Ethernet, dial-up telephone and/or other conventional data port connections, may be used to communicate with other devices. A virtual network interface, which is software based, is standard on all machines supporting TCP/IP. Platform 130 may also receive input via input/output (I/O) device 240, which may be a keyboard, pointing device, or other input devices. Platform 130 may also present information and interfaces via display 250 to a user.

Bus 260 may be a bi-directional system bus of any size. In at least one embodiment, bus 260 may contain thirty-two address bit lines for addressing a memory 220 and thirty-two bit data lines across which data is transferred among the components. Alternatively, multiplexed data/address lines may be used instead of separate data and address lines.

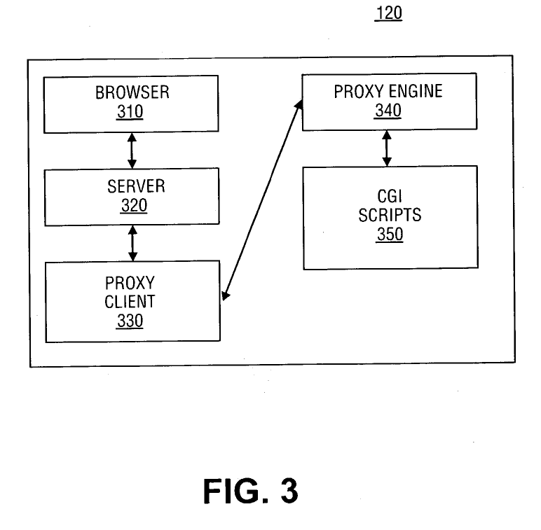

FIG. 3 illustrates an exemplary program 120 for installation consistent with an embodiment of the invention. Program 120 may include a logical system that comprises one or more programs functioning as an installer. Program 120 may include a browser 310, server 320, proxy client 330, proxy engine 340 and CGI Scripts 350.

Browser 310 may be any type of browser, including text-based and graphic-based browsers. In at least one embodiment, the browser is native to the platform on which the program is being run. For Microsoft Windows™ based devices, for example, the Internet Explorer™ browser is a native browser. In UNIX systems, the text browser Lynx can be used. Server 320 may be any type of web server that is capable of executing an external program. In at least one embodiment, server 320 supports the Common Gateway Interface (CGI) method. It should be understood that browser 310 and server 320 do not need to be run on the same platform on which installation is taking place; either or both may be run on a remote platform.

Proxy client 330 provides a communication link between server 320 and proxy engine 340. Proxy client 330 and proxy engine 340 are programs which may be developed and/or written in any computing language, such as the C programming language, the C++ programming language or object-oriented languages. Proxy engine 340 is capable of interpreting HTML data, retrieving previously saved answers, and reconstructing the FORM part of the HTML data by changing the default values. In at least one embodiment, proxy engine 340 may control the order of execution of the CGI scripts, identify and manipulate the HTML FORM data received from the CGI scripts, store user answers to be loaded in later, and automatically answer the CGI questions without user interaction. CGI Scripts 350 may be shell scripts, which perform installation once necessary information is collected from a user. CGI Scripts 350 communicate through proxy engine 340 and proxy client 330 to server 320.

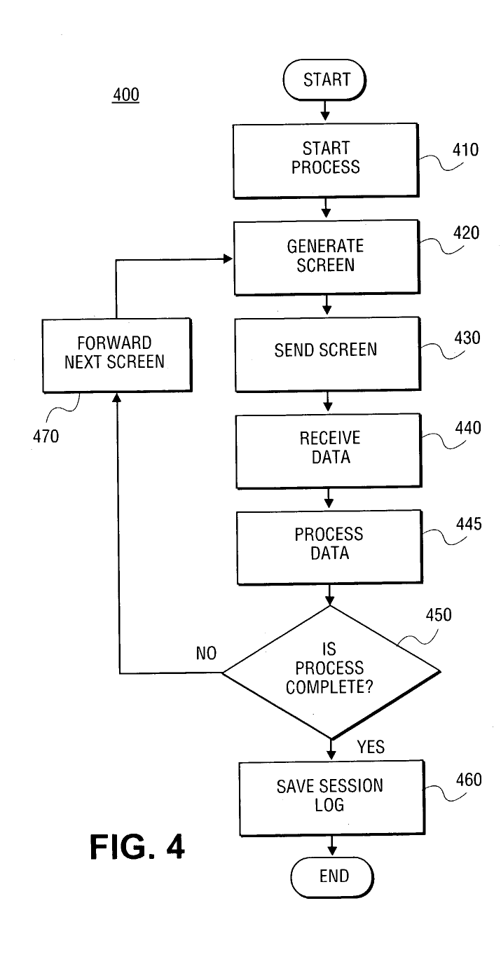

FIG. 4 is a general flow diagram of an exemplary method for recreating configuration data, consistent with an embodiment of the invention. As illustrated in FIG. 4, the process begins with the start of the install process (step 410). In at least one embodiment, the install process begins when a GET request is received from browser 310. In another embodiment, the install process begins when browser 310 connects to server 320 and server 320 calls proxy engine 340 via proxy client 330 as a standard CGI script. CGI Script 350 generates a screen (step 420) for the current step in the configuration process. In at least one embodiment, a screen is generated in response to a GET or POST request. The screen may include FORM data requesting information from a user. A FORM in HTML code is defined through the text within the FORM tags <FORM> and </FORM>. FORM data is the data between those tags, as will be understood by one skilled in the art of HTML programming. In another embodiment, proxy engine 340 looks up what the current CGI program or “screen” should be and executes it. In yet another embodiment, before the screen reaches the user, it is processed by proxy engine 340. When the screen reaches proxy engine 340 from CGI scripts 350, proxy engine 340 parses, or evaluates, the HTML data, which makes up the screen. This parsed HTML data consists of three groups of data:

1) Data before the <FORM> tag;

2) Data between the <FORM> tag and the </FORM> tag; and

3) Data after the </FORM> tag.

The data in group 2, between the <FORM> tags, is further processed to identify or create a FORM key. The FORM key may be generated by combining the “ID,” “TITLE,” and “NAME” attributes if they exist. Additionally, details of each type of HTML element, a FORM element, between the FORM tags are identified.

Each element is assigned a unique element key based on the type of element and “NAME” attribute. When the FORM key and element keys are combined, they make up a unique value in the system. Using the FORM key and element key, the system stores the value of the element used to capture (or replay) an installation session.

After the processing is done, the default value of each FORM key is changed to match the stored value. Stored values may be values stored following a previous installation. The screen comprising FORM elements is sent to the user (step 430). In another embodiment, the screen is sent to server 320 using proxy client 330. Proxy engine 340 reconstructs the HTML document and passes it on to proxy client 330, which passes it to server 320, which serves it to the user.

Data is received from the user (step 440). In at least one embodiment, the user may choose to change the answer or “submit” the answer provided. Proxy engine 340 captures the user data, and stores it in memory with the associated element key. The data is processed and sent to CGI Scripts 350 (step 445). In at least one embodiment, proxy engine 340 passes the submitted data to the CGI script for validation and processing. Proxy engine 340 checks if the installation process is complete (step 450). If installation is complete the process terminates. For example, the CGI script may send an exit request to the proxy engine, thereby stopping the install. If the installation is not complete, the next screen created by the CGI Script will be processed (NO; step 470). The steps may be repeated until the software installation has been completed.

Once installation has been completed, a session log, containing the element key values, is saved (YES; step 460). In at least one embodiment, at the end of the software installation, all of the values in memory are written to a file, such as a session log. This file may be used to pre-load all of the answers back into the system memory. The stored values may be used to guide the user through an install based on a previous install instead of using default configuration information. In another embodiment, the proxy engine 340 may contain a component that bypasses the server and automatically answers the questions based on the information in memory. The default values are used to modify the default output of a CGI script before it gets to a server, without the CGI script having knowledge of the modifications.

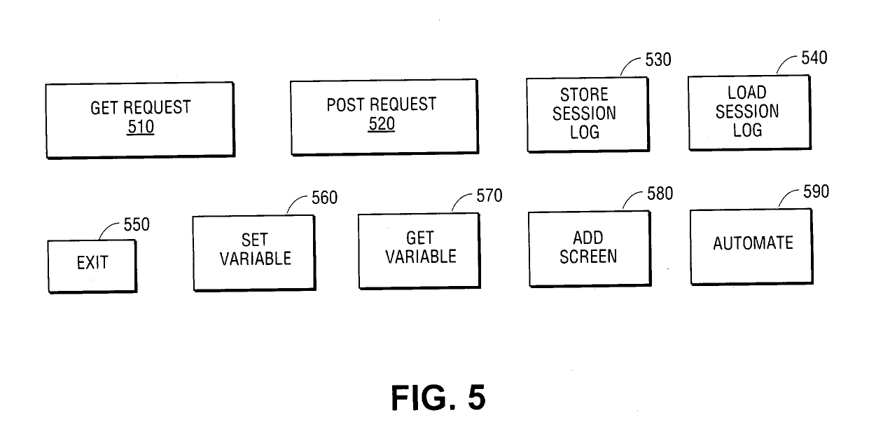

FIG. 5 is a block diagram of exemplary types of proxy engine requests. Requests may be received from various clients, such as a CGI client, screen, variable and automation clients. The CGI client acts as a CGI program and passes on CGI GET/POST requests to proxy engine 340. The other clients are executed either by the CGI programs or the program that starts up the installer in order to affect the way the install proceeds. The requests include GET Request 510, Post Request 520, Store Session Log 530, Load Session Log 540, Exit 550, Set Variable 560, Get Variable 570, Add Screen 580 and Automate 590.

For GET Request 510, proxy engine 340 executes a CGI Script, passing on the request. The CGI Script generates an output, such as a screen. Proxy engine 340 will parse the screen to determine the FORM data in the screen. Next, proxy engine 340 generates a unique key for each piece of FORM data. If the unique key does not exist in the system, proxy engine 340 creates default values. If default values already exist, proxy engine 340 regenerates FORM data using the default values from memory. A value for each FORM element is stored. A screen with a generated FORM is then sent to server 320.

For POST Request 520, proxy engine 340 will validate that the data in the POST request was expected, based on items associated with a FORM name. IF, for example, the FORM key is “XXX” the element keys may be of the form “XXX:Key1” “XXX:Key2” “XXX:Key3.”, The expected POST data should be of the form “Key1=data&Key2=data&key3=Data.” If so, the POST data is validated as “correct.” If the information received was not expected, validation fails and a warning may be sent to the user, with instructions for the browser to perform a GET request. In some exemplary embodiments, the system will automatically reset. In another embodiment, the values from the POST request are stored, and may overwrite information already stored. The GET or POST request is passed on and the CGI Script executes. If a response contains no data, a GET request is executed for the next CGI Script. If response contains data, then no GET request is executed and the data is passed back to the user.

For store session log 530, proxy engine 340 stores variables for data to a file in the FORM of “key”=“value”. For load session log 540, proxy engine 340 loads the variables from a file in the form of “key”=“value.” For exit request 550, proxy engine 340 exits. For set variable request 560, proxy engine 340 manually sets a key's value. For get variable request 570, proxy engine 340 returns the value of a key. For add screen 580, proxy engine 340 adds a screen or screens to the list of CGI scripts. For Automate 590, proxy engine 340 generates a GET Request and then responds to the GET Request. After generating the GET request, proxy engine 340 generates a POST Request based on a FORM key from memory and performs a POST Request. If there is an error, such as no more screens, proxy engine 340 stops and waits, going back into a manual mode.

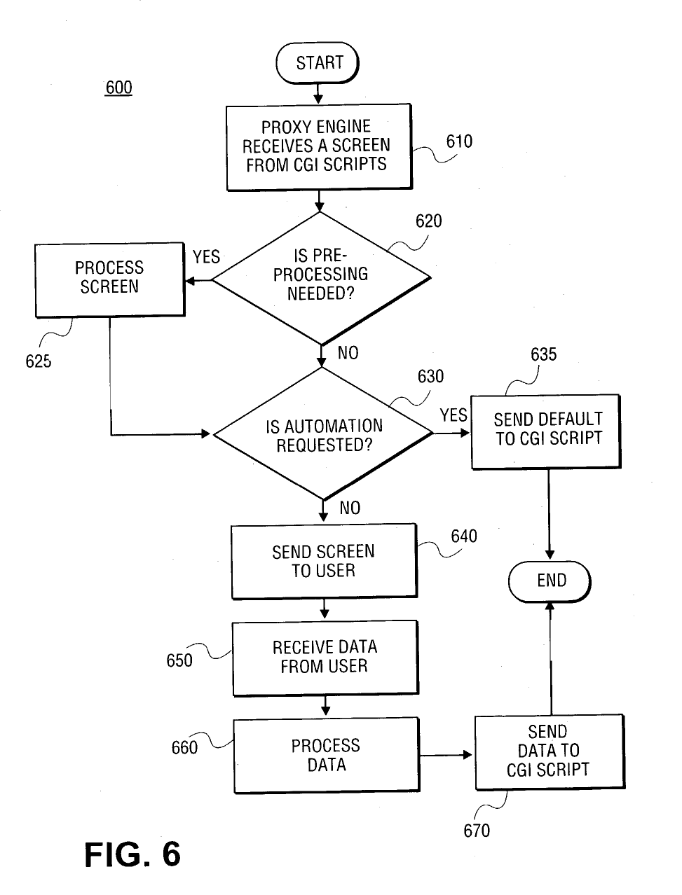

FIG. 6. is a flow diagram of another exemplary method for evaluating and handling a request from a client, consistent with an embodiment of the invention. As illustrated in FIG. 6, proxy engine 340 receives a screen from CGI Scripts 350 (step 610). The screen may be in the form of standard HTML code and include a FORM data entry section. Proxy engine 340 checks if any pre-processing is needed (step 620). If pre-processing is needed, the screen is processed (YES; step 625). In at least one embodiment, pre-processing by proxy engine 340 includes performing a number of steps. First, the screen may be broken down into three parts parts, 1) data BEFORE the <FORM> tag; 2) data between the <FORM . . . > and </FORM> tag; and 3) data after the </FORM> tag. The data in between the <FORM . . . > and </FORM> tags is evaluated. The evaluated information is broken apart into the various FORM elements. For example:

<HTML>
<HEADER>
<TITLE>The page title</TITLE>
</HEADER>
<BODY>
<P>This is introductory stuff outside of the FORM.
<FORM name=“mysample” METHOD=POST>

Please enter your name: <INPUT TYPE=“TEXT” VALUE=“”

NAME=“username”/>

Please enter your age: <INPUT TYPE=“TEXT” VALUE=“”
NAME=“age”/>
<INPUT TYPE=“SUBMIT” VALUE=“Next” NAME=“Next”/>

</FORM>
</BODY>

In the exemplary data above, Part 1 contains everything from “<HTML>” to “. . . of the FORM.” Part 2 contains everything from “<FORM name=“mysample> . . . ” to “</FORM>”. Part 3 contains everything AFTER “</FORM>” until the end of the document. Part 2 is further broken down into a tree-like structure:

[Type: FORM Data: ‘name=“mysample” METHOD=POST’ Key:

“mysample” ]

|−> [ Type: OTHER Data: ‘Please enter your name:’ ]
|−> [ Type: INPUT Data: ‘TYPE=“TEXT”
VALUE=“” NAME=“username”’

Key: “mysample:username” ]

|−> [ Type: OTHER Data: ‘Please enter your age:’ ]
|−> [ Type: INPUT Data: ‘TYPE=“TEXT”
VALUE=“” NAME=“age”’ Key:

“mysample:age” ]

|−> [ Type: INPUT Data: ‘TYPE=“SUBMIT....” Key:

“mysample:Next:Type=Submit” ]

If memory was “blank” before, it will now contain:

mysample:username = “”
mysample:age = “”
mysample:Next:Type=Submit = “” (this is a special one as it has no real

value)

where mysample is the FORM key, and username is an element key. The values of elements of “mysample” are stored for future use. After processing the HTML code is reconstructed, by putting part 1 plus HTML code generated from the objects of part 2 followed by part 3. The values already stored in memory are used, i.e.:

mysample:username=“joe”

mysample:age=“21”

During regeneration of the HTML code for part 2, the HTML code using stored values will look like:

<FORM name=“mysample” METHOD=POST>

Please enter your name: <INPUT TYPE=“TEXT” VALUE=“joe”

NAME=“username”/>

Please enter your age: <INPUT TYPE=“TEXT” VALUE=“21”
NAME=“age”/>
<INPUT TYPE=“SUBMIT” VALUE=“Next” NAME=“Next”/>

</FORM>

If no pre-processing is needed, proxy engine 340 checks if automation is enabled or requested (NO; step 630). In at least one embodiment, the user can request automation either by preloading a session log or loading a session log during start-up. If automation is requested, proxy engine 340 uses default values as appropriate and pauses when the system needs user attention. The default values used may be previously-stored configuration data retrieved from memory. In at least one embodiment, status information may be supplied via proxy engine 340 to server 320, even on an automated install. If the user does not have a browser, another component of the automation client will return any status information if there is an error. If automation is requested, proxy engine 340 will send the default response to CGI Script 350 (YES; step 635).

If automation is not requested, the screen is sent to the user (NO; step 640). In at least one embodiment, the screen is sent to the user via server 320 and browser 310. After viewing the screen, the user may choose to leave the information as displayed or modify the information. If the user views the data and decides not to modify it, the user indicates to the system to continue by, for example, clicking on a button. If the user modifies the information, the user enters the new information into the screen, and then indicates to the system to continue by, for example, clicking the “next” button. Alternatively, the system may continue automatically, such as for example, after a period of time. In step 650, data is received from the user (step 650). Continuing with the example above, if no changes are made to the information, the POST request will look like:

username=joe&age=21 &Next=Next

The data is processed and the data is sent to the CGI Script (steps 660 and 670). In at least one embodiment, proxy engine 340 parses the POST request and adds in the previously-saved FORM key to the beginning of each posted segment of FORM elements, such as username and age. It may then validate that “mysample:username,” “mysample:age,” “mysample:Next” all exist in memory. If they do not, proxy engine 340 stops processing the POST request and generates an HTML page that tells the user that the POST data was incorrect. The HTML page may instruct the browser to automatically reload, which may execute a GET request to restart the process. If the values were in memory, there is no error may be found and the process continues. The values from the POST request are saved into memory.

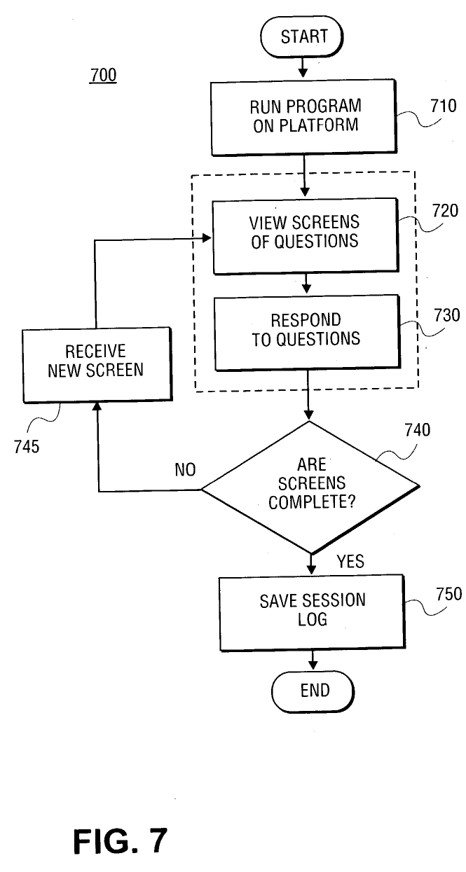

FIG. 7 is a flow diagram illustrating an exemplary method for user interaction consistent with an embodiment of the present invention. The user executes program 120 on platform 130 (step 710). In at least one embodiment, this includes starting proxy engine 340, running request add screens 580, starting server 320, and starting browser 310 which is connected to server 320. In another embodiment, the user loads a session log to enable automation. In another embodiment, enable automation is run at the user's request to enable automation of the process. The user views screens of questions and responds to the questions (steps 720 and 730). In at least one embodiment, these steps take place on a platform other than that in which the program is being installed. This allows for remote loading and status checking. A check is made if all the screens have been completed (step 740). If they are not complete, a new screen will be received (NO, step 745) and the process repeats. If the requests are complete, the session log created from the responses may be saved (YES; step 750) before the program exits. Part of an exemplary session log may look like this:

“install_type:install_type” = “default_install”
“install_location:install_prefix” = “/opt”
“install_guitools:guiTools” = “yes”
“choose_package:cross_tools“ = “on”
“choose_package:lsp_source” = “on”
“choose_package:target_files” = “on”
“cdrom_location:cdrom_location” = “/mnt/cdrom_host_bdb021202”
“target_cdrom_location:cdrom_location_1” =

“/mnt/cdrom_x86_pentium3_bdb021125_1_rel”

“target_cdrom_location:cdrom_location_2” =

“/mnt/cdrom_x86_pentium3_bdb021125_1_rel”

“target_cdrom_location:cdrom_volume_1” =
“MVL-CGE-3.0-bdb021125_1-

x86_pentium3-00001”

“target_cdrom_location:cdrom_volume_2” =
“MVL-CGE-3.0-bdb021125_1-

x86_pentium3-00001”

“target_cdrom_location:num_cdroms” = “2”
“choose_lsp_1:lsp_none” = “on”
“choose_lsp_1:x86_pentium3-force-cpci735” = “”
“choose_lsp_1:x86_pentium3-ibm-x330” = “”
“choose_lsp_1:x86_pentium3-intel-tsrlt2” = “”
“choose_lsp_1:x86_pentium3-intel-zt5550” = “”
“choose_lsp_1:x86_pentium3-radisys-epc3307” = “”
“choose_lsp_1:x86 pentium3-radisys-epc3311” = “”
“anotherLSP:anotherLSP_1” = “yes”
“anotherLSP:anotherLSP_2” = “no”
“target_cdrom_location:cdrom_location_1 ” =

“/mnt/cdrom_x86_pentium3_bdb021125_1_rel”

“target_cdrom_location:cdrom_location_2” =

“/mnt/cdrom_x86_pentium3_bdb021125_1_rel”

“target_cdrom_location:cdrom_volume_1” =
“MVL-CGE-3.0-bdb021125_1-

x86_pentium3-00001”

“target_cdrom_location:cdrom_volume_2” =
“MVL-CGE-3.0-bdb021125_1-

x86_pentium3-00001”

“target_cdrom_location:num_cdroms” = “2”
“choose_lsp_2:lsp_none” = “”
“choose_lsp_2:x86_pentium3-force-cpci735” = “”
“choose_lsp_2:x86_pentium3-ibm-x330” = “”
“choose_lsp_2:x86_pentium3-intel-tsrlt2” = “”
“choose_lsp_2:x86_pentium3-intel-zt5550” = “”
“choose_lsp_2:x86_pentium3-radisys-epc3307” = “”
“choose_lsp_2:x86 pentium3-radisys-epc3311” = “on”
“anotherLSP:anotherLSP_1” = “yes”
“anotherLSP:anotherLSP_2” = “no”
“gen_hostconfig:target_ip_addr” = “1.2.3.41”

This exemplary session log stores values in a simple text format where “key”=“value.” The keys are unique and generated from the HTML information, which allow for the storage of values from one session to another. The keys can also be used in subsequent sessions as default values.

While embodiments or features of the invention have been described as being stored in memory, one skilled in the art will appreciate that these aspects can also be stored on or read from other types of computer-readable media, or secondary storage devices, such as hard disks, floppy disks, or CD-ROMs; a carrier wave from the Internet; or other forms of RAM or ROM. Similarly, the exemplary methods disclosed herein and other embodiments of the invention may conveniently be implemented in program modules that are based upon the flow charts in FIGS. 4, 6 and 7. Although exemplary programming languages are mentioned, one skilled in the art will appreciate that the operations, stages and procedures described above and illustrated in the accompanying drawings may be implemented in any of a variety of programming languages. Moreover, there are many computers and operating systems that may be used in practicing the invention and therefore no detailed computer program could be provided which would be applicable to these many different systems. Each user of a particular computer will be aware of the language and tools which are most useful for that user's needs and purposes.

Furthermore, the above-noted features and embodiments of the present invention may be implemented in various environments. Such environments and related applications may be specially constructed for performing the various processes and operations of embodiments of the invention or they may include a general-purpose computer or computing platform selectively activated or reconfigured by program code to provide the necessary functionality. The exemplary processes disclosed herein are not inherently related to any particular computer or other apparatus, and aspects of these processes may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Embodiments of the present invention also relate to computer-readable media that include program instructions or program code for performing various computer-implemented operations based on the methods and processes of the invention. The program instructions may be those specially designed and constructed for the purposes of implementing embodiments of the invention, or they may be of the kind well known and available to those having skill in the computer software arts. Examples of program instructions include machine code, such as produced by a compiler, and files containing a high level code that can be executed by the computer using an interpreter.

Other embodiments of the invention will be apparent to those skilled in the art from consideration of the specification and practice of the exemplary embodiments disclosed herein. Therefore, it is intended that the specification and examples be considered as exemplary only, with a true scope and spirit of the invention being indicated by the scope of the following claims and their equivalents.

What is claimed is:

1. A method of processing configuration data of a first program executing on a computer system, the method comprising:
determining first configuration data associated with the first program, the first configuration data comprising one or more parameters;
generating a web-based browser screen comprising the first configuration data and displaying the web-based browser screen to a user via a browser;
receiving via the browser second configuration data representing the first configuration data with one or more modifications to the one or more parameters of the first configuration data; and
storing the second configuration data.

2. The method of claim 1, wherein determining first configuration data comprises:
parsing a session log comprising one or more parameters relating to prior execution of one or more second programs, including the first program,
determining which of the parameters in the session log relate to the first program; and
wherein generating a web-based browser screen comprising the first configuration data comprises inserting into the web-based browser screen the values associated with the one or more parameters relating to the first program.

3. The method of claim 1, wherein storing the second configuration data comprises generating a session log comprising one or more parameters relating to the execution of the first program.

4. The method of claim 3, further comprising:
using the session log when executing a second program.

5. The method of claim 3, wherein the execution of the first program is a first installation.

6. The method of claim 5, further comprising:
using the session log in a second installation.

7. A method of processing configuration data of a first program executing on a computer system, the method comprising:
determining first configuration data associated with the first program, the first configuration data comprising one or more parameters;
generating a web-based browser screen comprising the first configuration data and displaying the web-based browser screen to a user via a browser;
receiving via the browser screen confirmation of the first configuration data; and
storing the first configuration data.

8. The method of claim 7, wherein determining first configuration data comprises:
parsing a session log comprising one or more parameters relating to prior execution of one or more second programs including the first program; and
determining which of the parameters in the session log relate to the first program; and
wherein generating a web-based browser screen comprising the first configuration data comprises inserting into the web-based browser screen the values associated with the one or more parameters relating to the first program.

9. The method of claim 7, wherein the execution of one or more programs is a first installation.

10. The method of claim 9, further comprising:
using the session log in a second installation.

11. A system processing configuration data of a first program executing on a computer system, the system comprising:
means for determining first configuration data associated with the first program, the first configuration data comprising one or more parameters;
means for generating a web-based browser screen comprising the first configuration data and displaying the web-based browser screen to a user via a browser;
means for receiving via the browser second configuration data representing the first configuration data with one or more modifications to the one or more parameters of the first configuration data; and
means for storing the second configuration data.

12. The system of claim 11, wherein means for determining first configuration data comprises:
means for parsing a session log comprising one or more parameters relating to prior execution of one or more second programs, including the first program; and
means for determining which of the parameters in the session log relate to the first program; and
wherein generating a web-based browser screen comprising the first configuration data comprises inserting into the web-based browser screen the values associated with the one or more parameters relating to the first program.

13. The system of claim 11, wherein storing the second configuration data comprises means for generating a session log comprising one or more parameters relating to the execution of the first program.

14. The system of claim 13, further comprising:
means for using the session log when executing a second program.

15. A system processing configuration data of a first program executing on a computer system, the system comprising:
means for determining first configuration data associated with the first program, the first configuration data comprising one or more parameters;
means for generating a web-based browser screen comprising the first configuration data and displaying the web-based browser screen to a user via a browser;
means for receiving via the browser screen confirmation of the first configuration data; and
means for storing the first configuration data.

16. The system of claim 15, wherein means for determining first configuration data comprises:
means for parsing a session log comprising one or more parameters relating to prior execution of one or more second programs including the first program; and
means for determining which of the parameters in the session log relate to the first program; and
wherein generating a web-based browser screen comprising the first configuration data comprises inserting into the web-based browser screen the values associated with the one or more parameters relating to the first program.

17. The system of claim 15, wherein the means for execution of one or more programs is a first installation.

18. The system of claim 17, further comprising:
means for using the session log in a second installation.

19. A computer-readable medium on which is stored instructions, which when executed perform steps in a method processing configuration data of a first program executing on a computer system, the steps comprising:
determining first configuration data associated with the first program, the first configuration data comprising one or more parameters;
generating a web-based browser screen comprising the first configuration data and displaying the web-based browser screen to a user via a browser;
receiving via the browser second configuration data representing the first configuration data with one or more modifications to the one or more parameters of the first configuration data; and
storing the second configuration data.

20. The computer-readable medium of claim 19, wherein determining first configuration data comprises:
parsing a session log comprising one or more parameters relating to prior execution of one or more second programs, including the first program, and
determining which of the parameters in the session log relate to the first program; and
wherein generating a web-based browser screen comprising the first configuration data comprises inserting into the web-based browser screen the values associated with the one or more parameters relating to the first program.

21. The computer-readable medium of claim 19, wherein storing the second configuration data comprises generating a session log comprising one or more parameters relating to the execution of the first program.

22. The computer-readable medium claim 21, further comprising:
using the session log when executing a second program.

23. A computer-readable medium on which is stored instructions, which when executed perform steps in a method processing configuration data of a first program executing on a computer system, the steps comprising:
determining first configuration data associated with the first program, the first configuration data comprising one or more parameters;
generating a web-based browser screen comprising the first configuration data and displaying the web-based browser screen to a user via a browser;
receiving via the browser screen confirmation of the first configuration data; and
storing the first configuration data.

24. The computer-readable medium of claim 23, wherein determining first configuration data comprises:
parsing a session log comprising one or more parameters relating to prior execution of one or more second programs including the first program, and
determining which of the parameters in the session log relate to the first program; and
wherein generating a web-based browser screen comprising the first configuration data comprises inserting into the web-based browser screen the values associated with the one or more parameters relating to the first program.

25. The computer-readable medium of claim 23, wherein the execution of one or more programs is a first installation.

26. The computer-readable medium of claim 25, further comprising:
using the session log in a second installation.
